(19) United States
(12) Patent Application Publication
(10) Pub. No.: US 2022/0374662 A1
(43) Pub. Date: Nov. 24, 2022

(54) IMAGE PROCESSING APPARATUS AND METHOD FOR CONTROLLING IMAGE PROCESSING APPARATUS

(71) Applicant: SHARP KABUSHIKI KAISHA, Osaka (JP)

(72) Inventor: YUKARI EBI, Osaka (JP)

(21) Appl. No.: 17/740,587

(22) Filed: May 10, 2022

(30) Foreign Application Priority Data
May 19, 2021 (JP) 2021-084653

(51) Int. Cl. G06K 15/02; G06K 15/12; G06F 3/12

(52) U.S. Cl. CPC G06K 15/1806; G06K 15/129; G06F 3/1204; G06F 3/1238

(57) ABSTRACT

An image processing apparatus includes a storage that stores a setting value pertaining to execution of a job, a job executor that can execute the job based on the setting value, and a controller that controls the job executor on a basis of the setting value read from the storage. When reading the setting value, if a specific setting value is changed from an initial value, the controller restricts application of the specific setting value.

### BACKGROUND OF THE INVENTION

### Field of the Invention

The present disclosure relates to an image processing apparatus, and the like.

### Description of the Background Art

Some image processing apparatuses, such as multifunction peripherals, store setting values pertaining to job execution as history information (hereinafter referred to as “setting history information”) in a readable manner.

A user can read and reuse desired setting history information when executing a new job, or change the setting values as necessary, thereby reducing the burden of time and effort involved in executing the new job.

From the perspective of effective use of the setting history information, when a new job is executed with the use of the setting history information, it is preferable to display a setting screen on which the setting content at the time of execution of the setting history information is applied as it is. As a prior art fulfilling such a requirement, for example, such an image forming apparatus is known which manages a job setting screen and job history information, and displays a setting screen on which the setting content included in the job history information is applied, when displaying a setting screen of a new job that uses the job history.

In conventional techniques, the setting content at the time of job execution is applied and displayed in the setting screen of a new job as it is. However, if, for example, the setting history information pertaining to a job for which a time-specified transmission function that transmits image data at a specified time is set is read and executed by a user other than the user who executes the job, image data may be transmitted (erroneously) at a date and time unknown to the user who has read the setting history information, which could result in image data leakage.

Some setting history information does not produce a desired execution result unless the user who reads the setting history information for reuse understands the setting or change of a specific setting value. In addition to the above setting value pertaining to the time-specified transmission function, such specific setting values include, for example, a setting value that depends on a document (reading) such as color balance and color adjustment system and a setting value that affects a cost increase such as color mode and print color, in a copy job that outputs a printed matter by reading a document.

It is difficult for the user to fully understand the changes made to a specific setting value included in the read-out setting history information. The user who uses the setting history information for the purpose of reuse tend to be distracted by other setting values other than the setting values that they themselves set or change. Therefore, as described above, when the execution user has set the destination and transmission timing pertaining to the time-specified transmission function, or when the execution user has set or changed a setting that depends on a document or a setting value pertaining to cost increase, if the user does not understand the settings or changes, the user may not be able to obtain a desired job execution result. In addition, the user may suffer an unexpected disadvantage such as the leakage of confidential information or an unnecessary increase in printing costs.

The purpose of the present disclosure is to provide an image processing apparatus and an information processing method that can reliably obtain a job execution result desired by a user who reuses setting history information while maintaining the convenience of reusing the setting history information pertaining to the execution of a new job.

### SUMMARY OF THE INVENTION

In order to solve the above issue, an image processing apparatus according to the present disclosure includes a storage that stores a setting value pertaining to execution of a job, a job executor that can execute the job based on the setting value, and a controller that controls the job executor on a basis of the setting value read from the storage. When reading the setting value, if a specific setting value is changed from an initial value, the controller restricts application of the specific setting value.

Further, a method for controlling an image processing apparatus according to the present disclosure includes storing a setting value pertaining to execution of a job, executing the job on a basis of the setting value, and controlling execution of the job on a basis of the setting value that has been read. In the controlling, when reading the setting value, if a specific setting value is changed from an initial value, application of the specific setting value is restricted.

According to the present disclosure, it is possible to provide an image processing apparatus or the like that can reliably obtain a job execution result desired by a user who reuses setting history information while maintaining the convenience of reusing the setting history information pertaining to the execution of a new job.

### BRIEF DESCRIPTION OF THE DRAWINGS

FIG. 1 is an external perspective view for explaining an overall configuration of a multifunction peripheral according to a first embodiment.

FIG. 2 is a diagram illustrating a functional configuration of the multifunction peripheral according to the first embodiment.

FIG. 3 is a table illustrating an example of a configuration of setting history information.

FIGS. 4A, 4B, and 4C are tables illustrating an example of specific setting values.

FIG. 5 is a flowchart illustrating a processing flow according to the first embodiment.

FIG. 6 is a flowchart illustrating a processing flow according to the first embodiment.

FIG. 7 is a diagram illustrating an operation example of the first embodiment.

FIG. 8 is a diagram illustrating an operation example of the first embodiment.

FIG. 9 is a diagram illustrating an operation example of the first embodiment.

FIG. 10 is a diagram illustrating an operation example of the first embodiment.

FIG. 11 is a diagram illustrating an operation example of the first embodiment.

FIG. 12 is a flowchart illustrating a processing flow according to a second embodiment.

FIG. 13 is a diagram illustrating an operation example of the second embodiment.

FIG. 14 is a diagram illustrating an operation example of the second embodiment.

FIG. 15 is a diagram illustrating an operation example of the second embodiment.

FIG. 16 is a flowchart illustrating a processing flow according to a third embodiment.

FIG. 17 is a diagram illustrating an operation example of the third embodiment.

FIG. 18 is a diagram illustrating an operation example of the third embodiment.

FIG. 19 is a diagram illustrating an operation example of the third embodiment.

### DESCRIPTION OF THE PREFERRED EMBODIMENTS

Embodiments of the present disclosure will be described below with reference to the drawings. In the present disclosure, a multifunction peripheral that executes each function such as image transmission, copy, and fax on a job-by-job basis is described as an embodiment of an image processing apparatus. The following embodiments are examples for explaining the present disclosure, and the technical scope of the description set forth in the claims is not limited to the following description.

### 1 First Embodiment

In a first embodiment, a setting value that may trigger erroneous transmission, which is a setting value related to a communication setting in the setting history information pertaining to an image transmission job, is described as an example of specific setting values.

1.1 Functional Configuration

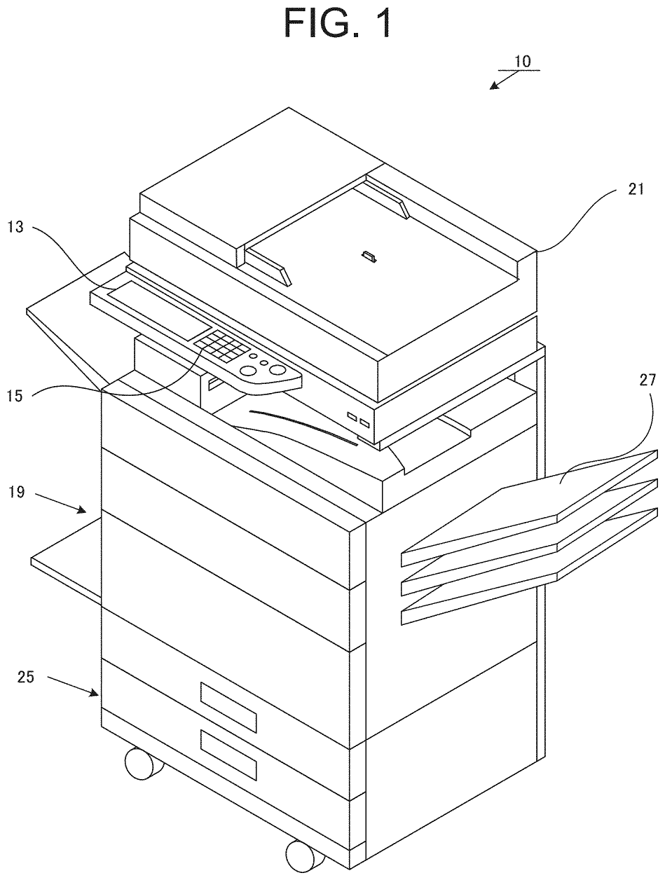

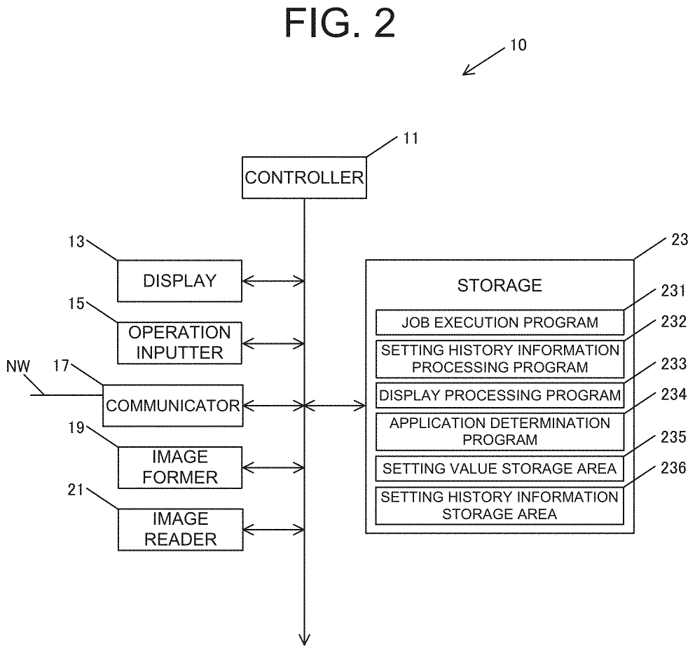

FIG. 1 is an external perspective view schematically illustrating an overall configuration of a multifunction peripheral 10 according to the first embodiment. FIG. 2 is a functional configuration diagram of a multifunction peripheral 10. The multifunction peripheral 10 includes a controller 11, a display 13, an operation inputter 15, a communicator 17, an image former 19, an image reader 21, and a storage 23.

The controller 11 controls the entire multifunction peripheral 10. The controller 11 is composed of one or more arithmetic devices (such as a central processing unit (CPU)). The controller 11 implements its functions by reading and executing various programs stored in the storage 23.

The display 13 displays various types of information to users or the like. The display 13 can be composed of, for example, a liquid crystal display (LCD) or an organic electro-luminescence (EL) display.

The operation inputter 15 accepts input information entered by users and others. The operation inputter 15 may include hardware keys (e.g., a numeric keypad), buttons, etc. The operation inputter 15 can be configured as a touch panel that allows input via the display 13. In this case, as an input method for the touch panel, a method such as a resistive film method, an infrared method, an electromagnetic induction method, or a capacitive sensing method may be employed.

The communicator 17 includes either a wired or wireless interface or both interfaces to communicate with other devices via a network (NW) such as a local area network (LAN), a wide area network (WAN), the Internet, a telephone line, and a fax line.

The image former 19 forms an image based on image data, on a paper as a recording medium. The image former 19 feeds a paper from a paper feeder 25, forms an image based on the image data on the paper, and then discharges the paper from a paper discharger 27. The image former 19 can be composed of, for example, a laser printer using an electrophotographic method. The image former 19 forms images using toner supplied from toner cartridges not illustrated corresponding to the toner colors (for example, cyan (C), magenta (M), yellow (Y), and black (K)).

The image reader 21 generates image data by scanning and reading a document image to be read. The image reader 21 can be configured as a scanner device with an image sensor such as a charge coupled device (CCD), a contact image sensor (CIS), or the like. There is no limitation on the configuration of the image reader 21 as long as the image reader 21 is configured to read the reflected light image from document image with an image sensor and thus generate image data.

The storage 23 stores various programs and data necessary for the operation of the multifunction peripheral 10. The storage 23 may be composed of a storage device including, for example, a random access memory (RAM), a hard disk drive (HDD), a solid state drive (SSD), a read only memory (ROM), or the like.

In the first embodiment, the storage 23 stores a job execution program 231, a setting history information processing program 232, a display processing program 233, and an application determination program 234, and secures a setting value storage area 235, a setting history information storage area 236.

The job execution program 231 is a program that is read by the controller 11 in order to perform processing associated with the execution of each function such as image transmission, copy, and fax. The controller 11 that has read the job execution program 231 executes a job by controlling a job executor such as the display 13, the operation inputter 15, the communicator 17, the image former 19, and the image reader 21. Further, the controller 11 that has read the job execution program 231 executes various jobs on the basis of the setting values included in the setting history information.

The setting history information processing program 232 is a program that the controller 11 reads when, for example, acquisition of a setting value or the like pertaining to job execution, generation of setting history information, and various kinds of processing on the setting history information are to be performed. The controller 11 that has read the setting history information processing program 232 acquires the setting value pertaining to the job execution, and stores the acquired setting value in the setting value storage area 235. Further, the controller 11 generates the setting history information based on the acquired setting value, and stores the generated setting history information in the setting history information storage area 236.

The display processing program 233 is a program that is read by the controller 11 when displaying a display screen that displays the setting history information, a setting screen for accepting input of various setting values pertaining to the job execution, a home screen that accepts switching of each job function, or the like. Further, when determining that a specific setting value in setting history information has been changed from an initial value, the controller 11 that has read the display processing program 233 performs display control that restricts the application of the setting value.

The application determination program 234 is a program that is read by the controller 11 when determining whether a specific setting value included in setting history information has been changed from an initial value. The controller 11 that has read the application determination program 234 determines whether a specific setting value included in setting history information has been changed from an initial value when reading the setting history information accompanying the execution of a new job. If determining that a specific setting value has been changed from an initial value, the controller 11 restricts the application of the specific setting value in accordance with the user's authentication status. In restricting the application of a setting value, the controller 11 can, for example, apply an initial value to the job execution in place of the setting value, thereby making the setting value unset, or can control the display of the part pertaining to the setting value to be hidden, thereby making the specific setting value unavailable.

The setting value storage area 235 is a storage area for storing setting values pertaining to the execution of a job. The setting values include, for example, a color mode, a resolution, a format, a density, and the like set by the user or the device default values held by the device per se.

The setting history information storage area 236 is a storage area for storing the setting history information in the form of a data table or the like. The setting history information according to the present disclosure can be configured as history information in which an identifier such as a job ID for uniquely identifying information is attached to the information including a combination of information related to job execution history such as job type, execution user name, start date and time, and mode, and part or all of the setting values stored in the setting value storage area 235. The setting history information stored in the setting history information storage area 236 is called as appropriate when executing a job, making application determinations, or the like based on the setting history information.

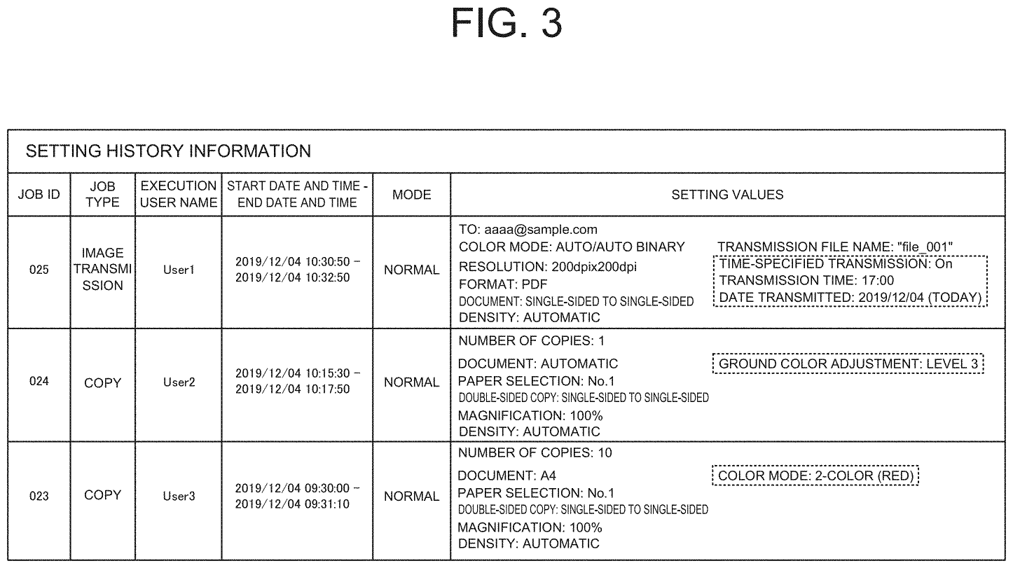

FIG. 3 is a diagram illustrating a configuration example of the setting history information. For example, the information exemplified by job ID “025” is an example of setting history information about an image transmission job. The setting history information of the job ID “025” includes, as information about an execution history, a job type “image transmission”, an execution user name “User1”, a start date and time—end date and time “Dec. 4, 2019 10:30:50-Dec. 4, 2019 10:32:50, and a mode “normal”. Here, the mode is a value that indicates whether the job pertaining to the setting history information has been executed in a normal mode via a normal setting screen or a simple mode via a simple setting screen that is a simplified version of the normal setting screen.

FIG. 3 illustrates, as the setting values pertaining to the job ID “025”, among the setting values related to the image transmission job, the setting values particularly pertaining to document reading, such as color mode “auto/auto binary”, resolution “200 dpi×200 dpi”, format “PDF”, document (reading side) “single-sided to single-sided”, and density “automatic”. The types and values of setting values that can be included in the setting history information are not limited to the example in FIG. 3.

As in the setting history information exemplified by the job ID “025”, when the user makes a setting pertaining to the time-specified transmission function that may trigger erroneous transmission as one function of the image transmission job, the set value can be stored as the setting value. The setting history information related to the job ID “025” is also an example of the setting history information having the setting values related to the time-specified transmission function that transmits the file (transmission file name: file_001) generated by document reading started at the date and time “Dec. 4, 2019 10:30:50” to the address “aaaa@sample.com” at time “17:00” “today (Dec. 4, 2019)”.

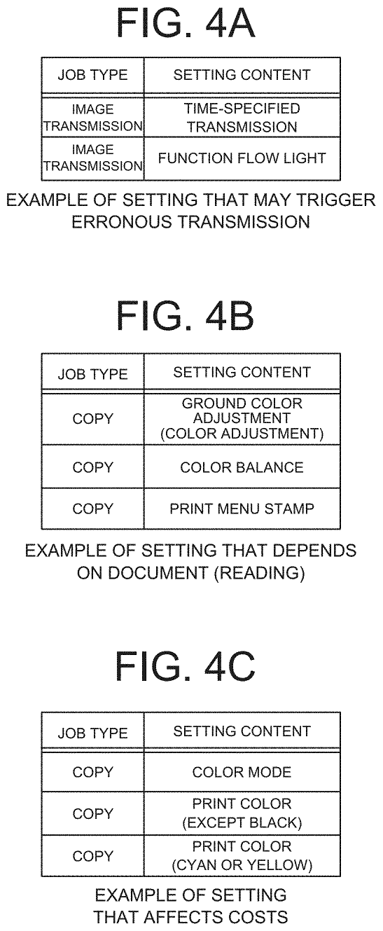

When reusing setting history information pertaining to an image transmission job, if the setting history information includes a setting value that may trigger erroneous transmission, the multifunction peripheral 10 according to the first embodiment restricts the application of the setting value to a job to be executed. In an image transmission job, specific setting values that may also trigger erroneous transmission include a function flow light function (transmission while copying), as illustrated in FIG. 4A.

1.2 Processing Flow

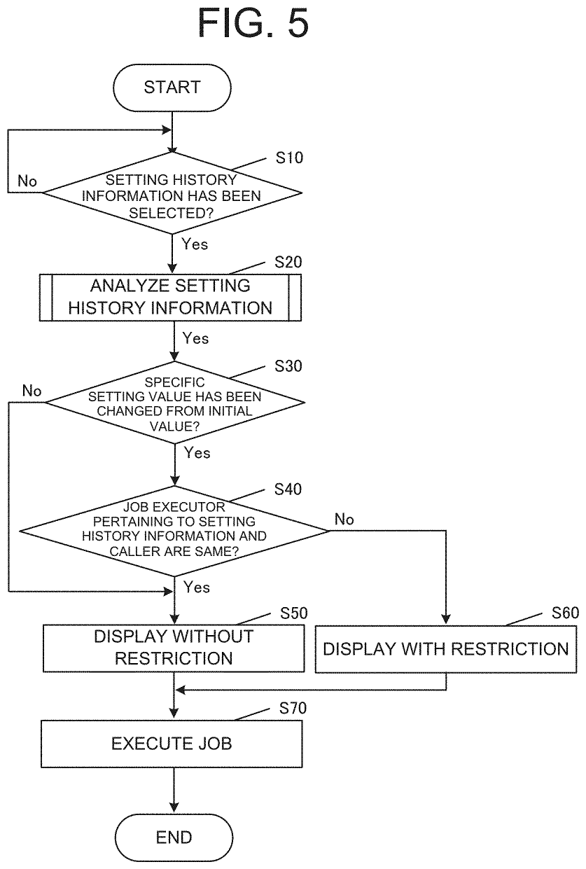

FIG. 5 is a flowchart illustrating processing by the multifunction peripheral 10. In the following description, for example, it is assumed that an image transmission job is executed, and the setting history information pertaining to the job is stored in the setting history information storage area 236 in the manner illustrated in FIG. 3.

The controller 11 determines whether the setting history information has been selected by the user (step S10). The user can select desired setting history information from the setting history information displayed in the setting history display screen described below.

When the desired setting history information is selected by the user, the controller 11 reads the setting history information from the setting history information storage area 236 and analyzes the setting history information (if Yes in step S10, then step S20).

On the basis of the result of the analysis of the setting history information, the controller 11 determines whether a specific setting value included in the analyzed setting history information has been changed from an initial value (step S30).

If determining that a specific setting value included in the analyzed setting history information has been changed from an initial value, the controller 11 determines whether the job executor pertaining to the setting history information and the caller as the login user of the setting history information are the same (if Yes in step S30, then step S40).

If determining that the job executor pertaining to the setting history information and the caller of the setting history information are the same, the controller 11 applies a specific setting value without restriction (if Yes in step S40, then step S50). Further, even if determining that a specific setting value included in the setting history information has not been changed from the initial value, the controller 11 applies the specific setting value without restriction (if No in step S30, then step S50).

On the other hand, if determining that the job executor pertaining to the setting history information and the caller of the setting history information are the same, the controller 11 restricts the application of the specific setting value (if No in step S40, then step S60). It is also possible to configure so as to unconditionally restrict the application of the specific setting value when the user authentication is disabled, or to unconditionally restrict the application of the specific setting value, regardless of the identity of the job executor pertaining to the setting history information and the caller of the setting history information. The presence or absence of restrictions on the application of specific setting values and the restriction method can be changed as appropriate in the system settings.

Upon receipt of an instruction to execute a job based on the setting history information displayed on the display 13, the controller 11 executes the job and ends the processing (step S70).

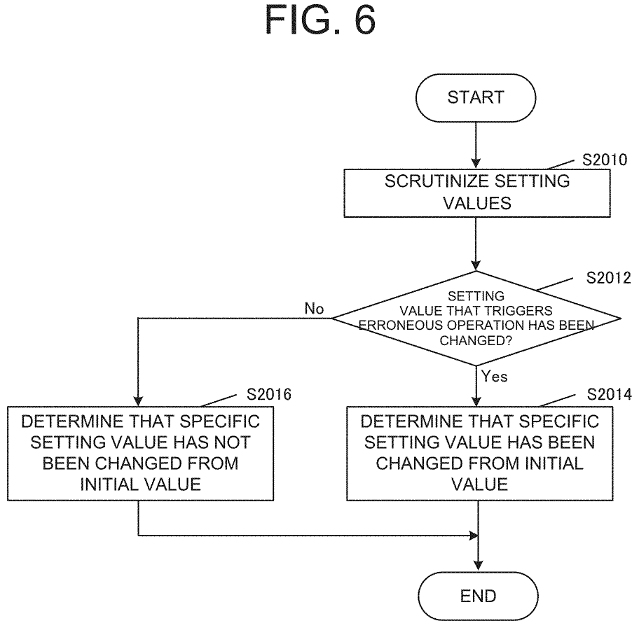

Next, the details of the processing in step S20 of FIG. 5 will be described using the flowchart of FIG. 6.

When starting to analyze the setting history information, the controller 11 scrutinizes the setting values included in the setting history information (step S2010).

The controller 11 determines whether the setting value that triggers an erroneous operation as a specific setting value has been changed from an initial value (step S2012). In the first embodiment, when a setting pertaining to the time-specified transmission function is made (when a setting value is set), it is treated as if the setting value that triggers an erroneous operation has been changed from the initial value. If determining that the setting value that triggers an erroneous operation has been changed from the initial value, the controller 11 determines that the specific setting value has been changed from the initial value and ends the processing (if Yes in step S2012, then step S2014).

On the other hand, if determining that the setting value that triggers an erroneous operation has not been changed from the initial value, the controller 11 determines that the specific setting value has not been changed from the initial value and ends the processing (if No in step S2012, then step S2016).

1.3 Operation Example

Next, an operation example of the first embodiment will be described. In the present disclosure, a touch panel type operation inputter 15 provided on the screen of the display 13 detects the user's presses on each button area or the like divided on the screen, and enables each input by the user.

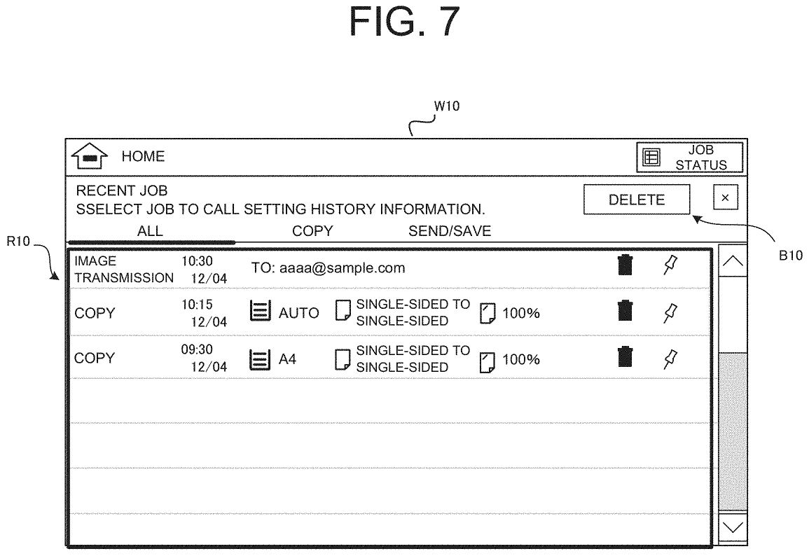

FIG. 7 is a configuration example of a setting history display screen W10. The setting history display screen W10 can be displayed by pressing the setting history display button or the like (not illustrated) provided on the home screen (not illustrated) and a setting screen described below. By selecting desired setting history information via the setting history display screen W10, the user can reuse the settings of the job pertaining to that setting history information to execute the job.

The setting history display screen W10 includes a setting history display area R10 and a delete button B10. The setting history display area R10 is configured, for example, to allow the setting history information pertaining to each job to be displayed in chronological order. There is no limitation on the display format of the setting history information. For example, as illustrated in FIG. 7, it is possible to adopt a display mode such as displaying the setting history information pertaining to all jobs, displaying only the setting history information pertaining to a specific job, displaying only the setting history information pertaining to a login user's job, displaying only the setting history information with the same setting values, displaying only the setting history information pertaining to jobs executed within a specific period of time, and displaying only the setting history information pertaining to a specific job execution user.

FIG. 7 is an example in which the setting history information pertaining to three jobs of image transmission job, copy job, and copy job is displayed in chronological order from the top to the bottom. The setting history information illustrated in FIG. 7 corresponds to the setting history information pertaining to the job IDs “025” to “023” illustrated in FIG. 3.

In the setting history display area R10, there are no particular restrictions on the setting value items that each setting history information indicates. Due to the limited displayable area, there is a limit to the number of setting value items that can be displayed at one time, but the setting value items to be displayed can be selected as appropriate. Further, FIG. 7 illustrates pinning to fix each setting history information on the screen, but there is no need to make the pinning a mandatory display item.

Each of the setting history information displayed in the setting history display area R10 is configured so as to be selected by the user. By selecting the desired setting history information, the user can easily execute a job based on the setting history information or a job similar to the job.

The delete button B10 accepts an instruction to delete the setting history information from the setting history display area R10. When the delete button B10 is pressed by the user, the controller 11 cancels the display of the setting history information in the setting history display area R10.

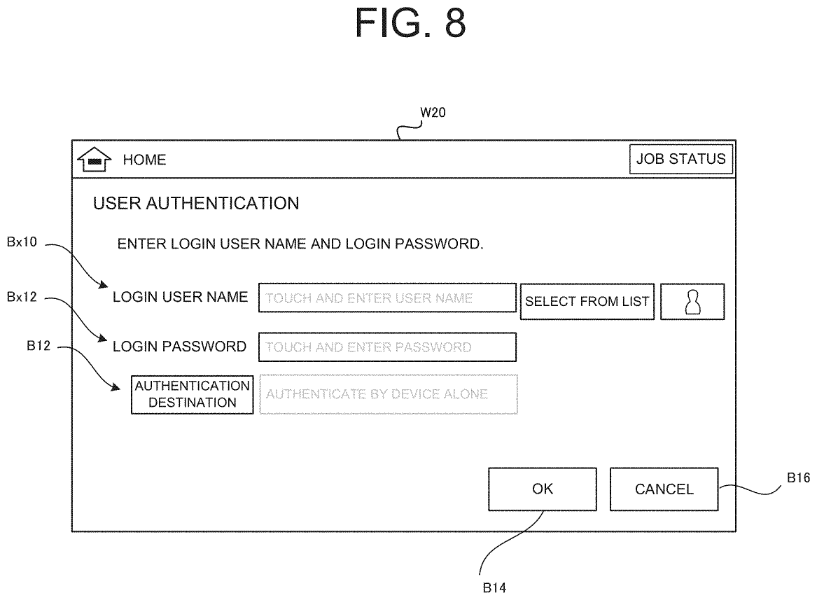

FIG. 8 is a diagram illustrating a configuration example of a user authentication screen W20 for performing user authentication. The user can log in to the multifunction peripheral 10 as a login user by performing user authentication via the user authentication screen W20.

The user authentication screen W20 includes a login user name input box Bx10, a login password input box Bx12, an authentication destination specifying button B12, an OK button B14, and a cancel button B16.

The login user name input box Bx10 is an input box which accepts input of a login user name. A user attempting to log in to the multifunction peripheral 10 enters the login user name in the login user name input box Bx10. The login user name can also be selected from a separately established user name list.

The login password input box Bx12 is an input box that accepts the input of the login password corresponding to the login user name. The user attempting to log in to the multifunction peripheral 10 enters the login password along with the login user name.

The authentication destination specifying button B12 is a button that accepts a specified user authentication destination. The authentication destination may be the device per se, or it is possible to specify, for example, an authentication server separately established on the network. When authentication by a single device is specified as the authentication destination, the controller 11 authenticates the user by comparing the entered login user name and login password with authentication information prepared in advance (e.g., a combination of user name and password). Meanwhile, when using an authentication server or the like on the network, the controller 11 can also perform user authentication by transmitting the entered login user name and login password to the authentication server and receiving the authentication result from the authentication server. The user authentication can also be performed with the use of possession authentication using integrated circuit (IC) cards and terminal devices such as smartphones, or biometric authentication such as fingerprint or face recognition.

The OK button B14 accepts the input of an instruction to confirm the input operation by the user. The user presses the OK button B14 when confirming the input to the login user name input box Bx10 or the login password input box Bx12, and the specification of the authentication destination via the authentication destination specifying button B12. The cancel button B16 accepts cancellation instruction input of the input operation by the user.

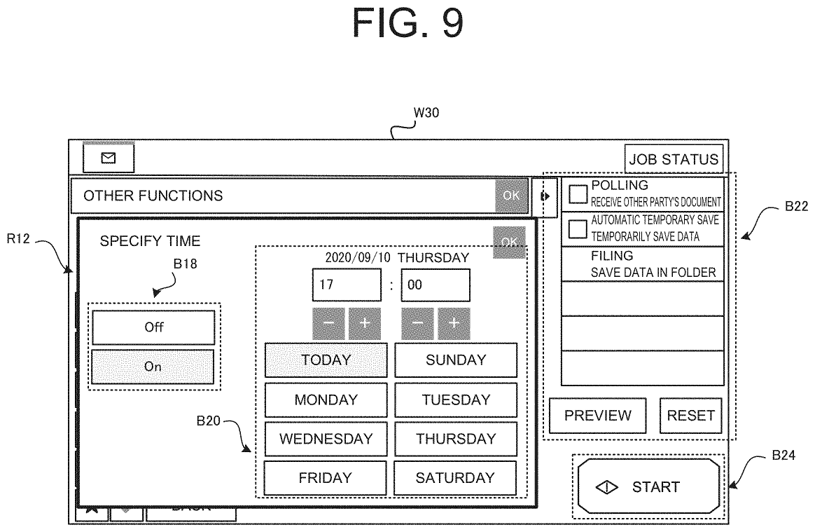

FIG. 9 is a configuration example of a time-specified transmission setting screen W30 for setting a time-specified transmission function that is one function of the image transmission job. The time-specified transmission setting screen W30 can be displayed, for example, by pressing an “other functions” button (not illustrated) on the image transmission setting screen. FIG. 9 is an example of the time-specified transmission setting screen W30 when generating the setting history information pertaining to the job ID “025” in FIG. 3.

The time-specified transmission setting screen W30 includes a time-specified transmission setting display area R12, operation control buttons B22, and a start button B24.

In the time-specified transmission setting display area R12, setting switching buttons B18 and date and time setting buttons B20 are provided.

The setting switching buttons B18 are selection buttons that accept switching on/off of the time-specified transmission function. The date and time setting buttons B20 accept the specification of the execution date and time of image data transmission. The user can set a desired time by directly entering the desired time in the input box where the time is displayed or by using the “+” button or the “−” button. FIG. 9 is an example where the execution time of image data transmission is set by the user to “17:00”. Further, the user can also specify the day of the week of execution by selecting any of the day-of-week buttons including the “today” button. FIG. 9 illustrates a mode in which the execution date and time of image data transmission is specified by the time and the day of the week including today. However, as a matter of course, as long as a specific date can be specified, it is possible to adopt a calendar format or a format similar to this.

The operation control buttons B22 have a “Polling” button, “Auto Temporary Save” button, “Filing” button, and the like, in addition to a “Preview” button and “Reset” button. For example, by pressing the “Polling” button, the user can inquire a particular device about the presence of a document that can be received.

The start button B24 accepts input of an instruction to execute the time-specified transmission function. When the start button B24 is pressed, the controller 11 executes processing pertaining to time-specified transmission received via the time-specified transmission setting display area R12.

Next, an operation example will be described in which when an image transmission job with the time-specified transmission function set is executed and the generated setting history information includes the setting content pertaining to the time-specified transmission function.

After executing the image transmission job with the time-specified transmission function set, the controller 11 generates setting history information including a setting value pertaining to the time-specified transmission function. The controller 11 stores the generated setting history information in the setting history information storage area 236.

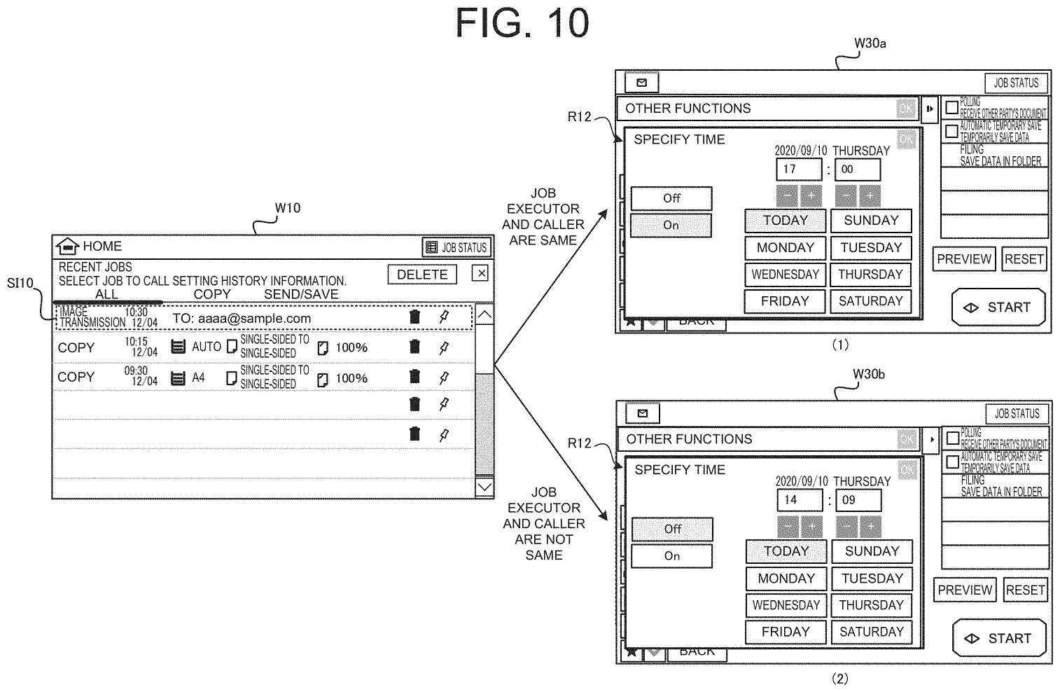

FIG. 10 is a diagram illustrating the control that the controller 11 performs when the user selects setting history information SI10 that includes a setting value pertaining to the time-specified transmission function.

When the user selects the setting history information SI10 via the setting history display screen W10, the controller 11 executes the processing according to steps S20 to S60 in FIG. 5 and the processing according to FIG. 6. As described with reference to FIG. 9, the setting history information SI10 includes a setting value related to the time-specified transmission function, and the setting value is an example of setting history information including a setting value that triggers an erroneous operation (see FIG. 3). Therefore, the controller 11 determines that the setting history information SI10 is setting history information in which a specific setting value has been changed from an initial value. Next, the controller 11 determines whether the executor of the job pertaining to the setting history information and the caller of the setting history information are the same.

If the job executor and the caller of the setting history information are the same, the controller 11 displays a time-specified transmission setting screen W30a illustrated in FIG. 10(1). In this case, the controller 11 shall display the setting value pertaining to the time-specified transmission function without restrictions, and displays the setting value as it is in the time-specified transmission setting display area R12. On the other hand, if the job executor and the caller of the setting history information are not the same, the controller 11 displays a time-specified transmission setting screen W30b illustrated in FIG. 10(2). In this case, the controller 11 shall display the setting value pertaining to the time-specified transmission function with restrictions, and changes the setting value to the initial value (current time; unset state) and displays same in the time-specified transmission setting display area R12. Additionally, the on/off setting for the time-specified transmission function is the off setting.

In many cases, the setting value (transmission time) pertaining to the time-specified transmission function and the time when the setting history information is called do not match. In such a case, it is also possible to store some of the setting values pertaining to the time-specified transmission function in such a manner that the setting values pertaining to the transmission time is stored, but the on/off setting of the time-specified transmission function is not stored, and thus all the setting values are not changed to initial values when the setting history information is called.

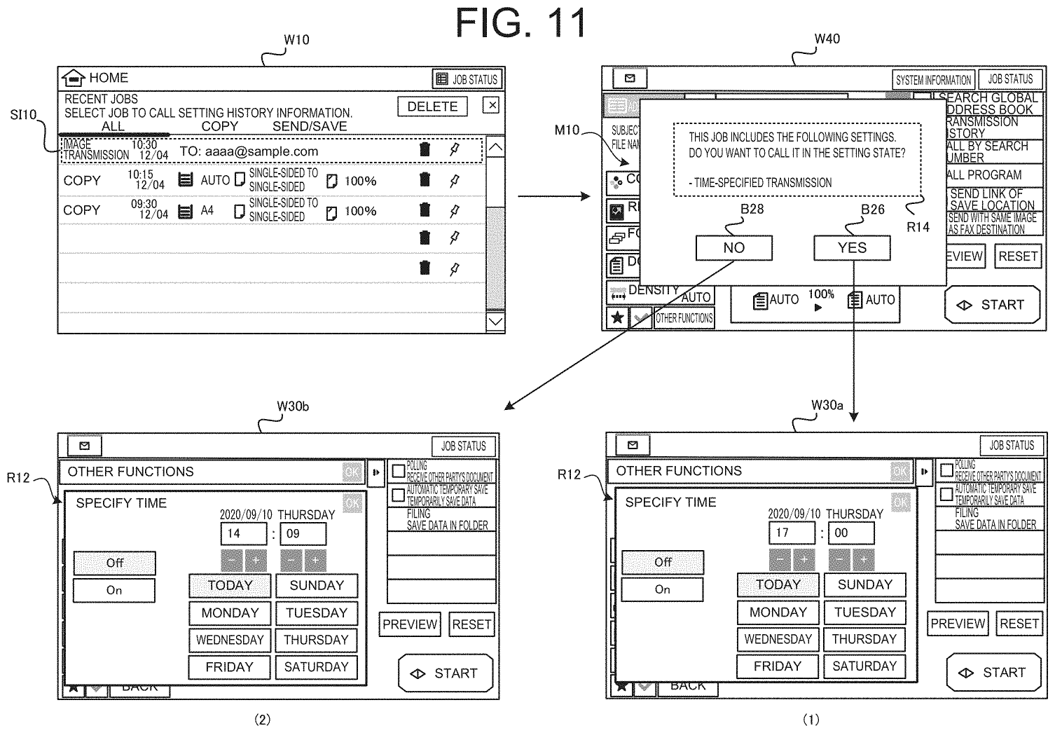

Next, another embodiment that the controller 11 implements when the job executor and the caller of the setting history information are not the same will be described with the use of FIG. 11.

When the user selects the setting history information SI10 via the setting history display screen W10 and the job executor and the caller of the setting history information are not the same, the controller 11 displays an inquiry screen M10 for the user on an image transmission setting screen W40.

The inquiry screen M10 includes a message display area R14, a Yes button B26, and a No button B28. The message display area R14 contains a message that the setting history information selected by the user includes a setting value pertaining to the time-specified transmission function and that inquires whether to apply the setting value.

The Yes button B26 accepts an instruction input to apply the setting value pertaining to the time-specified transmission function as it is when executing a new job based on the selected setting history information. The No button B28 accepts an instruction input not to apply the setting value pertaining to the time-specified transmission function.

When the Yes button B26 is pressed, the controller 11 displays the time-specified transmission setting screen W30a illustrated in FIG. 11(1). In this case, the controller 11 shall display the setting value pertaining to the time-specified transmission function without restrictions, and displays the setting value as it is in the time-specified transmission setting display area R12. On the other hand, when the No button B28 is pressed, the controller 11 displays the time-specified transmission setting screen W30b illustrated in FIG. 11(2). In this case, the controller 11 shall display the setting value pertaining to the time-specified transmission function with restrictions, and changes the setting value to the initial value (current time; unset state) and displays same in the time-specified transmission setting display area R12.

As described above, according to the first embodiment, when the job executor and the caller of the setting history information are the same, there is no loss of convenience in reusing the setting history information, and when the job executor and the caller of the setting history information are not the same, it is possible to restrict the application of the setting value pertaining to the time-specified transmission function that may trigger erroneous transmission. This prevents image data from being erroneously transmitted at a date and time unknown to the caller, or image data from being leaked.

### 2 Second Embodiment

In a second embodiment, a setting value that depends on a document (reading), which is a setting value related to a document setting in the setting history information pertaining to a copy job (or image transmission job), is described as an example of specific setting values.

2.1 Functional Configuration

The functional configuration of a multifunction peripheral according to the second embodiment may be the same as that of the multifunction peripheral 10 according to the first embodiment. Therefore, the description of the functional configuration of the multifunction peripheral according to the second embodiment is omitted, and the same sign as that of the multifunction peripheral 10 according to the first embodiment is used for the description.

An example of the setting history information covered by the second embodiment will be described using FIG. 3 again. The setting history information pertaining to job ID “024” in FIG. 3 is an example of setting history information about a copy job. The setting history information pertaining to the job ID “024” includes, as the execution history information, a job type “copy”, an execution user name “User2”, a start date and time—end date and time “Dec. 4, 2019 10:15:30-Dec. 4. 2019 10:17:50, a mode “normal”.

FIG. 3 illustrates, as the setting values pertaining to the job ID “024”, among the setting values related to the copy job, the setting values particularly pertaining to document reading, such as number of copies “1”, document “automatic”, paper selection “No. 1”, double-sided copy “single-sided to single-sided”, magnification “100%”, and density “automatic”. The types and values of setting values that can be included in the setting history information are not limited to the example in FIG. 3.

As exemplified by the job ID “024”, when the user makes a setting pertaining to the ground color adjustment that depends on document reading as one function of the copy job, the set value can be stored as the setting value. The setting history information pertaining to the job ID “024” is an example of setting history information with a setting value “level 3” related to ground color adjustment.

When reusing setting history information pertaining to a copy job, if the setting history information includes a setting value that depends on a document (reading), the multifunction peripheral 10 according to the second embodiment restricts the application of the setting value to a job to be executed. In copy jobs, specific setting values that also depend on a document can include color balance, print menu stamp, and the like, as illustrated in FIG. 4B.

2.2 Processing Flow

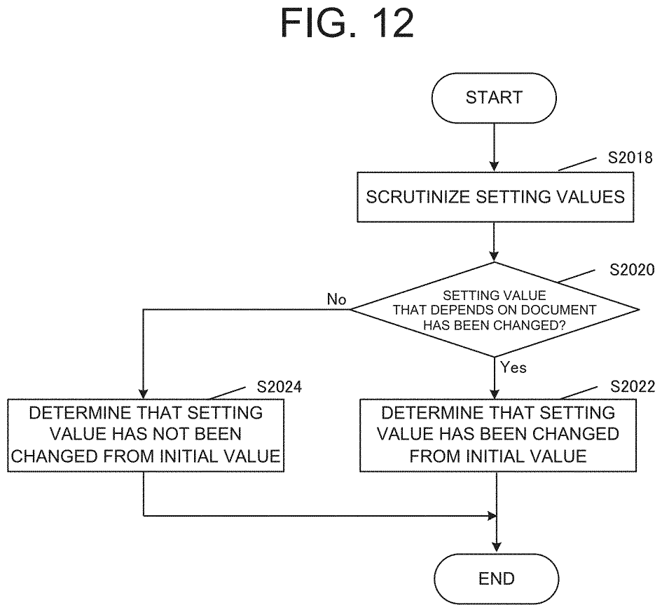

Next, a processing flow according to the second embodiment will be described. The processing according to the second embodiment can be implemented in the same way as the processing described in the first embodiment, except for step S20 in FIG. 5. The processing according to step S20 in FIG. 5 will be described with the use of the flowchart of FIG. 12.

When starting to analyze the setting history information, the controller 11 scrutinizes the setting values included in the setting history information (step S2018).

The controller 11 determines whether the setting value that depends on a document as a specific setting value has been changed from an initial value (step S2020). In the second embodiment, when a setting pertaining to the ground color adjustment is made (when a setting value is changed/set), it is treated as if the setting value that depends on a document has been changed from the initial value. If determining that the setting value that depends on a document has been changed from the initial value, the controller 11 determines that the specific setting value has been changed from the initial value and ends the processing (if Yes in step S2020, then step S2022).

On the other hand, if determining that the setting value that depends on a document has not been changed from the initial value, the controller 11 determines that the specific setting value has not been changed from the initial value and ends the processing (if No in step S2020, then step S2024).

2.3 Operation Example

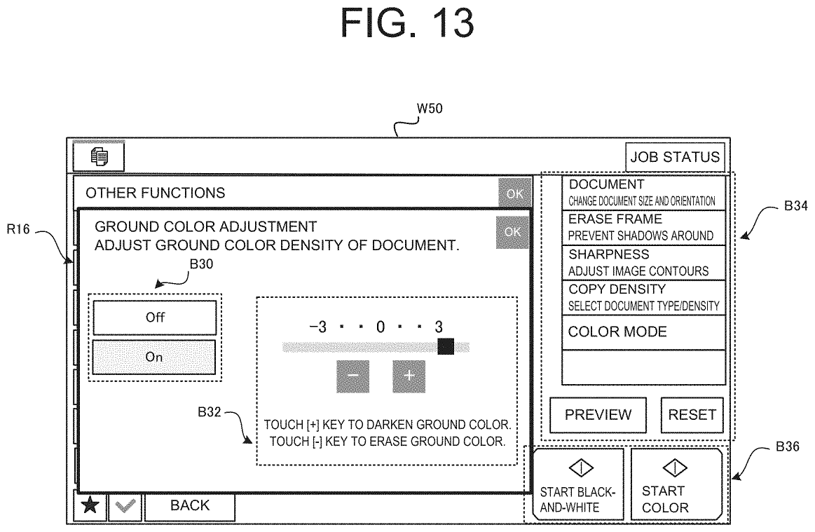

Next, an operation example of the second embodiment will be described. FIG. 13 is a configuration example of a ground color adjustment setting screen W50, which is one function of the copy job. The ground color adjustment setting screen W50 can be displayed, for example, by pressing an “other functions” button (not illustrated) on the copy setting screen. FIG. 13 is an example of the ground color adjustment setting screen W50 when generating the setting history information pertaining to the job ID “024” in FIG. 3.

The ground color adjustment setting screen W50 includes a ground color adjustment setting display area R16, operation control buttons B34, and start buttons B36.

In the ground color adjustment setting display area R16, setting switching buttons B30 and ground color adjustment setting buttons B32 are provided.

The setting switching buttons B30 are selection buttons that accept switching on/off of the ground color adjustment setting function. The ground color adjustment setting buttons B32 accept the setting of the ground color adjustment value. The user can select a desired ground color adjustment level with the use of the “+” or “−” buttons. FIG. 13 is an example where the ground color adjustment level is set to “level 3”.

In addition to the “Preview” and “Reset” buttons, the operation control buttons B34 have a “Document” button, an “Erase Frame” button, a “Sharpness” button, a “Copy Density” button, and a “Color Mode” button. For example, the user can change the document size and reading orientation by pressing the “Document” button.

The start buttons B36 accept input of an instruction to execute the ground color adjustment function. When the start buttons B36 are pressed, the controller 11 executes processing pertaining to ground color adjustment function received via the ground color adjustment setting display area R16.

Next, an operation example will be described in which when a copy job with the ground color adjustment function set is executed and the generated setting history information includes the setting content pertaining to the ground color adjustment function.

After executing the copy job with the ground color adjustment function set, the controller 11 generates setting history information including a setting value pertaining to the ground color adjustment function. The controller 11 stores the generated setting history information in the setting history information storage area 236.

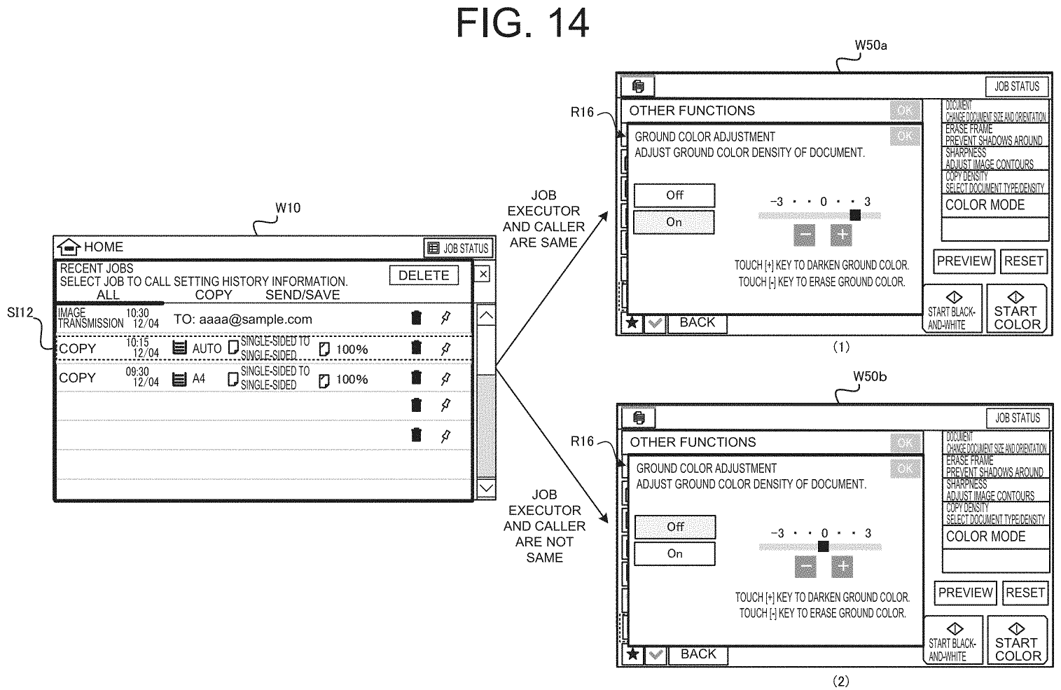

FIG. 14 is a diagram illustrating the control that the controller 11 performs when the user selects setting history information SI12 that includes a setting value pertaining to the ground color adjustment function.

When the user selects the setting history information SI12 via the setting history display screen W10, the controller 11 executes the processing according to steps S20 to S60 in FIG. 5 and the processing according to FIG. 12. As described with reference to FIG. 13, the setting history information SI12 includes a setting value related to the ground color adjustment function, and the setting value is an example of setting history information including a setting value that depends on a document (reading) (see FIG. 3). Therefore, the controller 11 determines that the setting history information SI12 is setting history information in which a specific setting value has been changed from an initial value. Next, the controller 11 determines whether the executor of the job pertaining to the setting history information and the caller of the setting history information are the same.

If the job executor and the caller of the setting history information are the same, the controller 11 displays a ground color adjustment setting screen W50a illustrated in FIG. 14(1). In this case, the controller 11 shall display the setting value pertaining to the ground color adjustment function without restrictions, and displays the setting value as it is in the ground color adjustment setting display area R16. On the other hand, if the job executor and the caller of the setting history information are not the same, the controller 11 displays a ground color adjustment setting screen W50b illustrated in FIG. 14(2). In this case, the controller 11 shall display the setting value pertaining to the ground color adjustment function with restrictions, and changes the setting value to the initial value (level 0; unset state) and displays same in the ground color adjustment setting display area R16. Additionally, the on/off setting for the ground color adjustment function is the off setting.

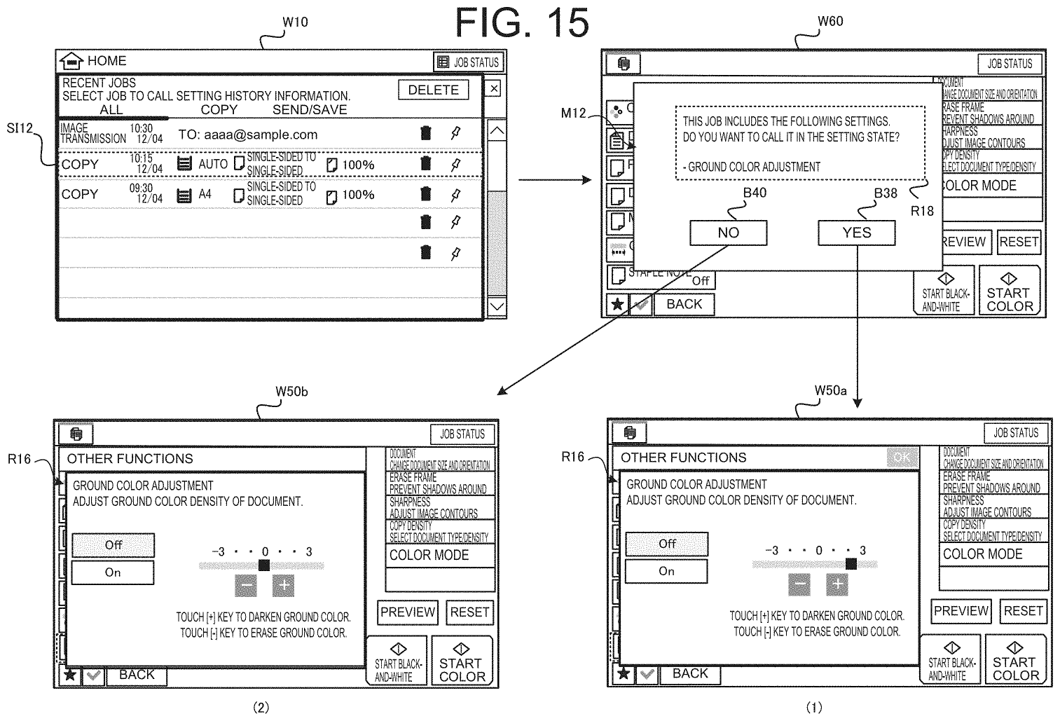

Next, another embodiment that the controller 11 implements when the job executor and the caller of the setting history information are not the same will be described with the use of FIG. 15.

When the user selects the setting history information SI12 via the setting history display screen W10 and the job executor and the caller of the setting history information are not the same, the controller 11 displays an inquiry screen M12 for the user on a copy setting screen W60.

The inquiry screen M12 includes a message display area R18, a Yes button B38, and a No button B40. The message display area R18 contains a message that the setting history information selected by the user includes a setting value pertaining to the ground color adjustment function and that inquires whether to apply the setting value.

The Yes button B38 accepts an instruction input to apply the setting value pertaining to the ground color adjustment function as it is when executing a new job based on the selected setting history information. The No button B40 accepts an instruction input not to apply the setting value pertaining to the ground color adjustment function.

When the Yes button B38 is pressed, the controller 11 displays the ground color adjustment setting screen W50a illustrated in FIG. 15(1). In this case, the controller 11 shall display the setting value pertaining to the ground color adjustment function without restrictions, and displays the setting value as it is in the ground color adjustment setting display area R16. On the other hand, when the No button B40 is pressed, the controller 11 displays the ground color adjustment setting screen W50b illustrated in FIG. 15(2). In this case, the controller 11 shall display the setting value pertaining to the ground color adjustment function with restrictions, and changes the setting value to the initial value and displays same in the ground color adjustment setting display area R16.

As described above, according to the second embodiment, when the job executor and the caller of the setting history information are the same, there is no loss of convenience in reusing the setting history information, and when the job executor and the caller of the setting history information are not the same, it is possible to restrict the application of the setting value that depends on a document (reading). This ensures that the user can obtain a desired job execution result without making a big difference in the output result as a printed matter.

### 3 Third Embodiment

In a third embodiment, a setting value that affects a cost, which is a setting value related to an image formation setting in the setting history information pertaining to a copy job, is described as an example of specific setting values.

3.1 Functional Configuration

The functional configuration of a multifunction peripheral according to the third embodiment may be the same as that of the multifunction peripheral 10 according to the first embodiment. Therefore, the description of the functional configuration of the multifunction peripheral according to the third embodiment is omitted, and the same sign as that of the multifunction peripheral 10 according to the first embodiment is used for the description.

An example of the setting history information covered by the third embodiment will be described using FIG. 3 again. The setting history information pertaining to job ID “023” in FIG. 3 is an example of setting history information about a copy job. The setting history information pertaining to the job ID “023” includes, as the execution history information, a job type “copy”, an execution user name “User3”, a start date and time—end date and time “Dec. 4, 2019 09:30:0-Dec. 4, 2019 09:31:10, a mode “normal”.

FIG. 3 illustrates, as the setting values pertaining to the job ID “023”, among the setting values related to the copy job, the setting values particularly pertaining to document reading, such as number of copies “10”, document “A4”, paper selection “No. 1”, double-sided copy “single-sided to single-sided”, magnification “100%”, and density “automatic”. The types and values of setting values that can be included in the setting history information are not limited to the example in FIG. 3.

As exemplified by the job ID “023”, when the user makes a setting pertaining to the color mode that affects a cost as one function of the copy job, the set value can be stored as the setting value related to print color. The setting history information pertaining to the job ID “023” is an example of setting history information with a setting value “2-color (red)” related to color mode.

When reusing setting history information pertaining to a copy job, if the setting history information includes a setting value related to a cost, the multifunction peripheral 10 according to the third embodiment restricts the application of the setting value to a job to be executed. In copy jobs, specific setting values that also affect a cost can include, as illustrated in FIG. 4C, a setting value for which the print color in the print menu is set to something other than “black”, and a setting value for which “Always print” is enabled in the document control, “Enable user color selection” is enabled, and the print color is set to “cyan” or “yellow”.

3.2 Processing Flow

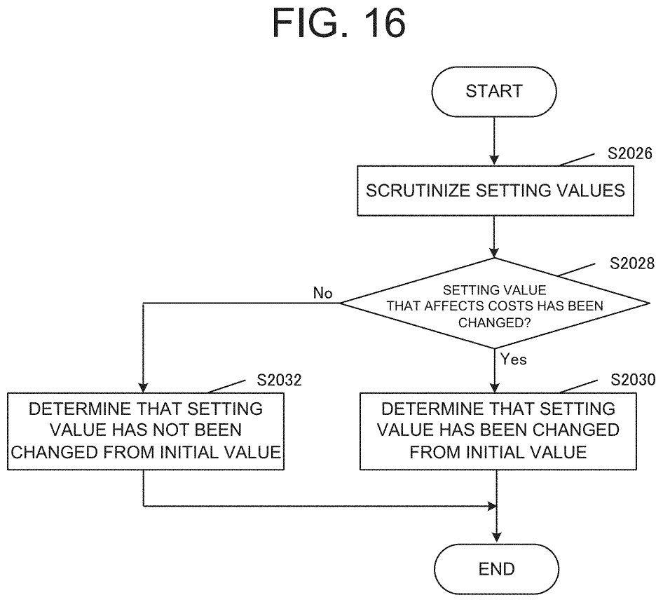

Next, the processing flow according to the third embodiment will be described. The processing according to the third embodiment can be implemented in the same way as the processing described in the first embodiment, except for step S20 in FIG. 5. The processing according to step S20 in FIG. 5 will be described with the use of the flowchart of FIG. 16.

When starting to analyze the setting history information, the controller 11 scrutinizes the setting values included in the setting history information (step S2026).

The controller 11 determines whether the setting value that affects a cost as a specific setting value has been changed from an initial value (step S2028). In the third embodiment, when a setting pertaining to the color mode is made (when a setting value is changed/set), it is treated as if the setting value that affects a cost has been changed from the initial value. If determining that the setting value that affects a cost has been changed from the initial value, the controller 11 determines that the specific setting value has been changed from the initial value and ends the processing (if Yes in step S2028, then step S2030).

On the other hand, if determining that the setting value that affects a cost has not been changed from the initial value, the controller 11 determines that the specific setting value has not been changed from the initial value and ends the processing (if No in step S2028, then step S2032).

3.3 Operation Example

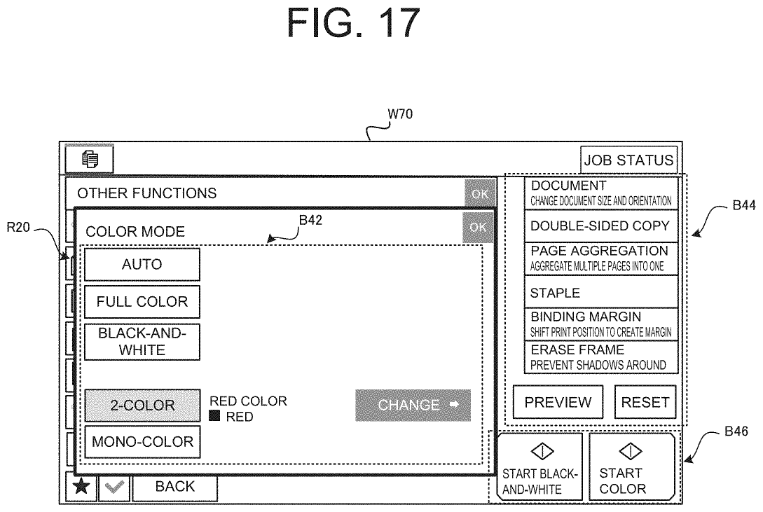

Next, an operation example of the third embodiment will be described. FIG. 17 is a configuration example of a color mode setting screen W70, which is one function of the copy job. The color mode setting screen W70 can be displayed, for example, by pressing an “other functions” button (ₙₒt illustrated) on the copy setting screen or a “color mode” button (not illustrated) provided in the operation control buttons. FIG. 17 is an example of the color mode setting screen W70 when generating the setting history information pertaining to the job ID “023” in FIG. 3.

The color mode setting screen W70 includes a color mode setting display area R20, operation control buttons B44, and start buttons B46.

The color mode setting display area R20 has color mode setting buttons B42.

The color mode setting buttons B42 accept color mode settings. By pressing any of an “Auto” button, a “Full Color” button, a “Black-and-White” button, a “2-Color” button, or a “Mono-Color” button, the user can select a color mode. FIG. 17 is an example where the color mode is set to “2-color (red)”.

In addition to the “Preview” and “Reset” buttons, operation control buttons B44 include a “Document” button, a “Double-Sided Copy” button, a “Page Aggregation” button, a “Staple” button, a “Binding Margin” button, an “Erase frame” button, and the like. For example, the user can change the document size and reading orientation by pressing the “Document” button.

The start buttons B46 accept input of an instruction to execute the color mode function. When the start buttons B46 are pressed, the controller 11 executes processing pertaining to the color mode function received via the color mode setting display area R20.

Next, an operation example will be described in which when a copy job with the color mode function set is executed and the generated setting history information includes the setting content pertaining to the color mode function.

After executing the copy job with the color mode function set, the controller 11 generates setting history information including a setting value pertaining to the color mode function. The controller 11 stores the generated setting history information in the setting history information storage area 236.

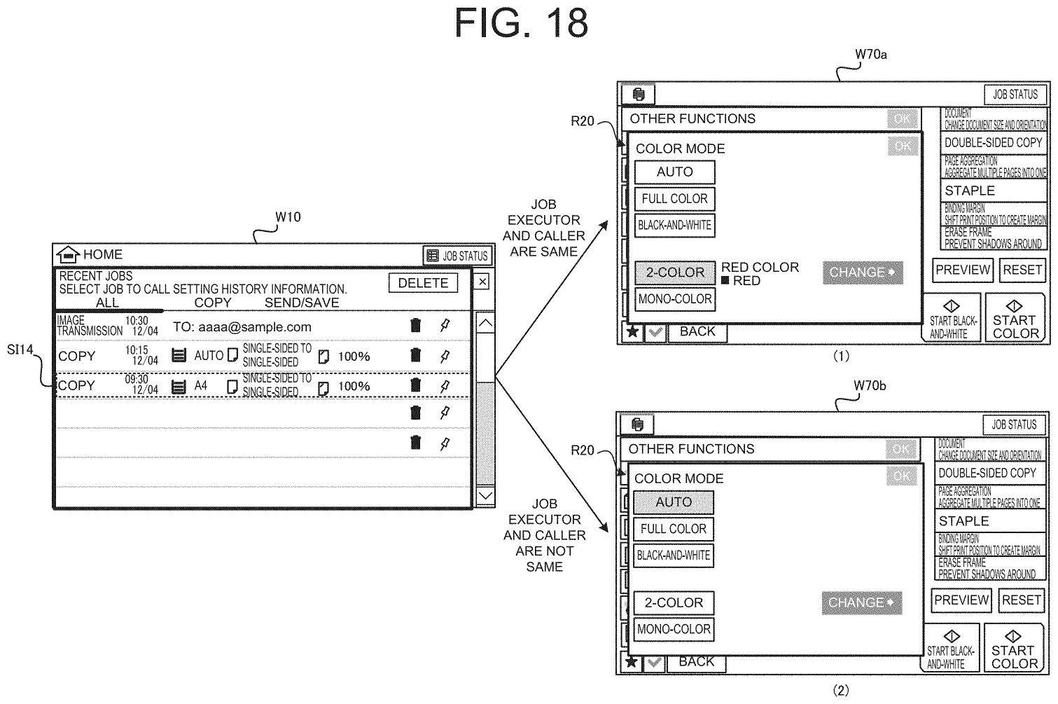

FIG. 18 is a diagram illustrating the control that the controller 11 performs when the user selects setting history information SI14 that includes a setting value pertaining to the color mode function.

When the user selects the setting history information SI14 via the setting history display screen W10, the controller 11 executes the processing according to steps S20 to S60 in FIG. 5 and the processing according to FIG. 16. As described with reference to FIG. 17, the setting history information SI14 includes a setting value related to the color mode function, and the setting value is an example of setting history information including a setting value that affects a cost (see FIG. 3). Therefore, the controller 11 determines that the setting history information SI14 is setting history information in which a specific setting value has been changed from an initial value. Next, the controller 11 determines whether the executor of the job pertaining to the setting history information and the caller of the setting history information are the same.

If the job executor and the caller of the setting history information are the same, the controller 11 displays a color mode setting screen W70a illustrated in FIG. 18(1). In this case, the controller 11 shall display the setting values pertaining to the color mode function without restrictions, and displays the setting values as they are in the color mode setting display area R20. On the other hand, if the job executor and the caller of the setting history information are not the same, the controller 11 displays a color mode setting screen W70b illustrated in FIG. 18(2). In this case, the controller 11 shall display the setting value pertaining to the color mode function with restrictions, and changes the setting value to the initial value (automatic in the present embodiment) and displays same in the color mode setting display area R20.

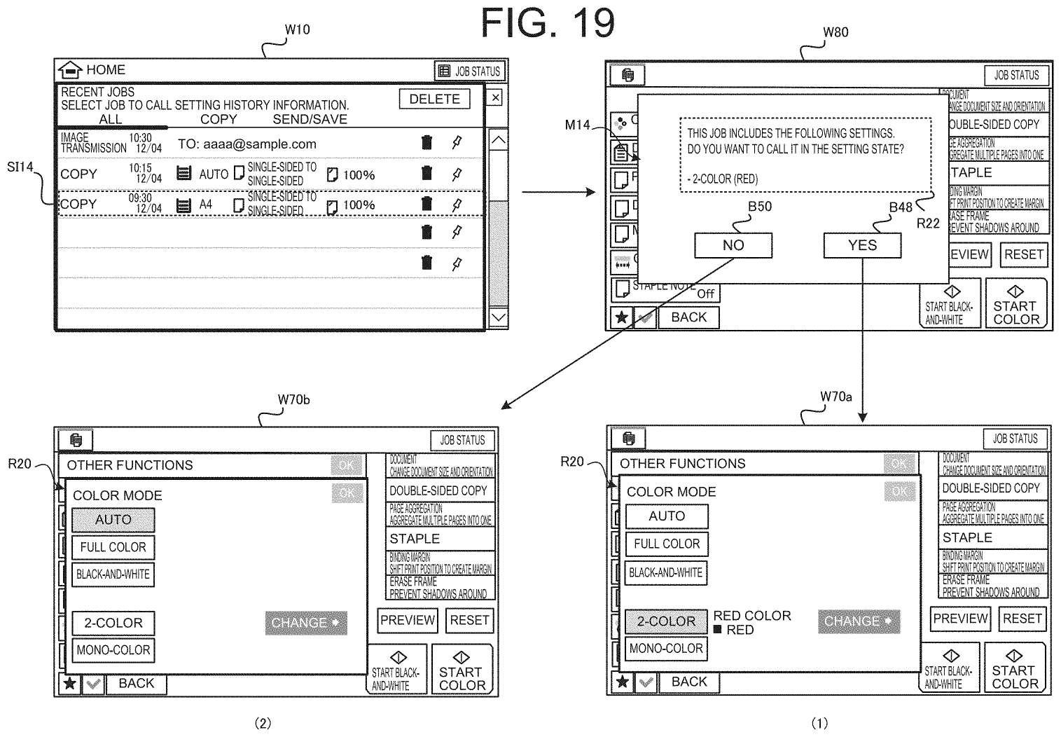

Next, another embodiment that the controller 11 implements when the job executor and the caller of the setting history information are not the same will be described with the use of FIG. 19.

When the user selects the setting history information SI14 via the setting history display screen W10 and the job executor and the caller of the setting history information are not the same, the controller 11 displays an inquiry screen M14 for the user on a copy setting screen W80.

The inquiry screen M14 includes a message display area R22, a Yes button B48, and a No button B50. The message display area R22 contains a message that the setting history information selected by the user includes a setting value pertaining to the color mode function and that inquires whether to apply the setting value.

The Yes button B48 accepts an instruction input to apply the setting value pertaining to the color mode function as it is when executing a new job based on the selected setting history information. The No button B50 accepts an instruction input not to apply the setting value pertaining to the color mode function.

When the Yes button B48 is pressed, the controller 11 displays the color mode setting screen W70a illustrated in FIG. 19(1). In this case, the controller 11 shall display the setting values pertaining to the color mode function without restrictions, and displays the setting values as they are in the color mode setting display area R20. On the other hand, when the No button B50 is pressed, the controller 11 displays the color mode setting screen W70b illustrated in FIG. 19(2). In this case, the controller 11 shall display the setting value pertaining to the color mode function with restrictions, and changes the setting value to the initial value (automatic in the present embodiment) and displays same in the color mode setting display area R20.

As described above, according to the third embodiment, when the job executor and the caller of the setting history information are the same, there is no loss of convenience in reusing the setting history information, and when the job executor and the caller of the setting history information are not the same, it is possible to restrict the application of the setting value that affects a cost. As a result, it is possible to prevent a disadvantage such as an increase in cost as a result of unexpected color printing of a printed matter.

The present disclosure is not limited to the above-described embodiments, and various modifications may be made. That is, the technical scope of the present disclosure also includes embodiments that may be obtained by combining technical measures that are modified as appropriate without departing from the gist of the present disclosure.

Further, although some of the above embodiments are described separately for convenience of explanation, it is needless to say that they may be combined and implemented within a technically allowable range.

Further, the program to be operated on the individual devices of the embodiments is a program which controls the CPU or the like (program which makes a computer work) so as to implement the functions of the above-described embodiments. The information handled by these devices is temporarily accumulated in a temporary storage device (e.g., RAM) during the processing, is then stored in various storage devices such as a read only memory (ROM) and an HDD, and is read, corrected, and written by the CPU as needed.

Here, a recording medium storing the program may be any of a semiconductor medium (e.g., a ROM or a non-volatile memory card), an optical recording medium/magneto-optical recording medium (e.g., a digital versatile disc (DVD), a magneto optical disc (MO), a mini disc (MD), a compact disc (CD), and a Blu-ray Disc (BD) (registered trademark)), and a magnetic recording medium (e.g., a magnetic tape, and a flexible disk).

Further, the functions according to the abovementioned embodiments are performed by executing the loaded program, and also the functions according to the present disclosure may be performed by processing in cooperation with an operating system, other application programs or the like, on the basis of the instruction of the program.

For market distribution, the program may be stored and distributed in a portable recording medium or transferred to a server computer connected via a network such as the Internet. In this case, it is needless to say that the present disclosure also includes a storage device of the server computer.

What is claimed is:

1. An image processing apparatus comprising:
a storage that stores a setting value pertaining to execution of a job;
a job executor that can execute the job based on the setting value; and
a controller that controls the job executor on a basis of the setting value read from the storage,
wherein when reading the setting value, if a specific setting value is changed from an initial value, the controller restricts application of the specific setting value.

2. The image processing apparatus according to claim 1, wherein the specific setting value is a setting value related to a communication setting.

3. The image processing apparatus according to claim 2, wherein the setting value related to a communication setting is a setting value that triggers erroneous transmission.

4. The image processing apparatus according to claim 1, wherein the specific setting value is a setting value related to a document setting.

5. The image processing apparatus according to claim 4, wherein the setting value related to a document setting is a setting value that depends on document reading.

6. The image processing apparatus according to claim 5, wherein the setting value that depends on document reading is a setting value pertaining to color balance or color adjustment.

7. The image processing apparatus according to claim 1, wherein the specific setting value is a setting value related to an image formation setting.

8. The image processing apparatus according to claim 7, wherein the setting value related to an image formation setting is a setting value related to a cost for outputting a printed matter.

9. The image processing apparatus according to claim 8, wherein the setting value related to a cost for outputting a printed matter is a setting value related to color printing.

10. The image processing apparatus according to claim 1, wherein when a user who executes the job and a user who logs in to the image processing apparatus are different, the controller restricts application of the specific setting value.

11. The image processing apparatus according to claim 10, wherein when restricting application of the specific setting value, the controller applies an initial value in place of the specific setting value.

12. A method for controlling an image processing apparatus, the method comprising:
storing a setting value pertaining to execution of a job;
executing the job on a basis of the setting value; and
controlling execution of the job on a basis of the setting value that has been read,
wherein in the controlling, when reading the setting value, if a specific setting value is changed from an initial value, application of the specific setting value is restricted.
